(19) United States
(12) Patent Application Publication
(10) Pub. No.: US 2010/0153992 A1
(43) Pub. Date: Jun. 17, 2010

(54) TARGETED ADVERTISING SYSTEM

(76) Inventor: Kianoush Namvar, Kista (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/580,632

(22) Filed: Oct. 16, 2009

Related U.S. Application Data
(63) Continuation of application No. 10/477,605, filed on Mar. 24, 2004, now abandoned.

(30) Foreign Application Priority Data
Jun. 1, 2001 (SE) 0101941-3

(51) Int. Cl. H04N 7/10; H04N 7/025; H04N 7/173

(52) U.S. Cl. 725/34; 725/115

(57) ABSTRACT

The invention relates to control of signal decoding in a set of subscriber receivers belonging to subscribers (s₁-s₃) of mass distributed coded signals (P₁; C₁-C₁₇, Cₓ₁-Cₓ₇), such as digital satellite channels, which are conveyed via different distribution resources (D₁-D₄). By means of a central transmission of control signals (d₁-d₈) to the subscriber receivers the decoding therein of the signals (P₁; C₁-C₁₇, Cₓ₁-Cₓ₇) can be controlled, such that during certain periods a signal including a content being directed to each subscriber (s₁-s₃) can be decoded in the respective subscriber receiver. Thereby commercial messages and other kinds of controlled or interest defined information can be focused to a relevant target group at the same time as the distribution resources (D₁-D₄) are utilized efficiently.

### CROSS-REFERENCE TO RELATED APPLICATIONS

This application is a continuation of U.S. patent application Ser. No. 10/477,605 filed on Mar. 24, 2004, which is a National Stage Entry and claims the benefit of filing date and priority to International Application No. PCT/SE02/01042 filed on May 31, 2002, which claims the benefit of the filing date and priority to Swedish Patent Application No. 0101941-3 filed on Jun. 1, 2001. All of the above applications are hereby incorporated by reference in their entirety.

### THE BACKGROUND OF THE INVENTION AND PRIOR ART

The present invention relates generally to decoding of mass distributed coded signals, such as digital satellite channels. Specifically, the invention relates to a method and a system for controlling signal decoding according to the preambles of claims 1 and 7 respectively.

For a long time, many different solutions have been known for transmitting generally available signals via electronic mass distribution media, such as radio broadcasting and terrestrial television. In addition to that, solutions for transmitting the corresponding signals via geostationary satellites have been available for a longer period of time. In recent years, it has also become possible to, by various means, limit the access to the distributed signals by means of different kinds of digital coding, such that the signals only may be decoded via authorized receivers.

The international patent application WO97/23996 discloses a method and an apparatus through which sound-, image and data content in transmitted signals are identified and provided with a corresponding label. These labels are used in an adapted receiver in order to control the reception of the signals, such that signals representing information that the user does not wish to reproduce can be replaced with alternative sound-, image- or data sequences. Thereby, for instance, objectionable or offensive program items may be filtered out according to a particular subscriber's requests.

However, program distributors of electronic mass distribution media, such as satellite television have hitherto only been able to transmit programs and commercial items according to very coarse selection preconditions. Typically, the selection has been based on the geographical coverage area of a signal transmitter, possibly in combination with a precondition whether the potential receivers/subscribers have signed a subscription with the distributor in question. It is nevertheless difficult to control the transmission of different types of signals to different subscribers within one and the same geographical coverage area. Therefore, any directed commercial messages and similar information have been spread to all the subscribers of a given distributor. The advertising in these media has thereby gained a relatively low degree of efficiency, at least in relation to the distribution cost. This in turn, has resulted in that advertisers whose products/services have a narrow geographical relevance and/or a small target group have often chosen alternative media for distribution of their messages, such as flyers and specialized magazines. At the same time, the degree of utilization of said electronic mass distribution media is sometimes comparatively low. During substantial parts of the day, some channels transmit pause signals or no signal at all. Naturally, this means a waste of transmission resources and expensive hardware investments.

The patent application GB, A, 2 344 099 describes a system for transmission of directed commercial items in connection with TV- and radio transmissions, which partly solves the above problem. Based on geographical data, for example registered by a GPS-receiver (GPS=Global Positioning System), and socioeconomic data pertaining to the subscribers a particular subscriber's receiver namely only decodes those commercial items which are regarded as relevant for that subscriber. The commercial items are transmitted in parallel with the payload programs and are stored locally in all receiver units. At a commercial break a user profile is consulted, which is also stored locally, and based on the profile contents a particular commercial item is replayed during the commercial break in question. Even if this solution increases the accuracy of the commercial items there are no possibilities to accomplish a central control over which information is decoded at which subscriber, since the user profiles are only stored locally in the respective receiver unit. Moreover, relatively complicated receiver units are required, which on one hand must have a capability to receive multiple parallel signals and on the other hand can store these signals for later replay. Furthermore, the majority of the signals are probably stored in vain, i.e. without ever being replayed for the subscriber due to the local filtering.

### SUMMARY OF THE INVENTION

The object of the present invention is therefore to alleviate the above problems and accomplish a solution, which on one hand, increases the commercial attraction of electronic mass distribution media by improving the relevance of the transmitted signals to the receivers under an efficient utilization of the available distribution resources and, on the other hand, is compatible with comparatively simple and cost efficient receiver units.

According to the invention those distribution resources are used over which some program distributors, at a given occasion, have chosen only to transmit pause information or completely refrain from transmitting information to a first group of subscribers in order to instead transmit payload signals from the same, or other, program distributors to a second group of subscribers.

Specifically, the above mentioned object is achieved according to one aspect of the invention by the initially described method for controlling signal decoding in different subscriber receivers, which is characterized by the following. A first set of subscriber receivers are presumed to decode a signal, which is transmitted via a first distribution resource. In connection with that this signal changes from representing a first type of information to instead represent a second type of information, a control signal is transmitted from a central position to the subscriber receivers in the first set. Initiated by the control signal, the signal decoding in the first set of subscriber receivers is thereafter directed from the first distribution resource to at least one second distribution resource, where a second type of information is conveyed. The signal decoding is controlled on basis of stored pieces of information pertaining to each subscriber, which is associated with the respective subscriber receivers, such that the second type of information has a relatively high degree of relevance to the subscribers in question.

According to another aspect of the invention, the object is achieved by the initially described system for controlling signal decoding in different subscriber receivers, which is characterized in that the system includes a central control unit, which in turn contains means for transmitting a control signal to a first set of subscriber receivers that decode a signal being transmitted via a first distribution resource in connection with the signal changing from representing a first type of information to instead represent a second type of information. Moreover, the central control unit includes means for controlling the signal decoding from the first distribution resource to at least one second distribution resource, which conveys at least one second type of information. The signal decoding is thereby directed on basis of stored pieces of information pertaining to each subscriber being associated to the respective subscriber receiver.

A change of signal type should, in this context, be given a very wide meaning and thus need not indicate that the signal changes from representing a particular type of content, such as a “program”, to representing a different type of content, such as a “commercial”, however it may equally well reflect, for example a transition from a first commercial to a second commercial, from a first program to a second program or from a certain program transmitted via a particular distribution resource to the same program transmitted via another distribution resource.

The invention allows an efficient usage of the transmission capacity of the distribution resources for transmission of regular programs as well as transmission of commercial messages. Since the invention also enables an apt direction of target group focused information the cost effectiveness can be increased considerably in the electronic channel distribution systems. This, of course, favors all interested parties in the form of operators, program distributors, advertisers and subscribers.

### BRIEF DESCRIPTION OF THE DRAWINGS

The present invention is now to be explained more closely by means of preferred embodiments, which are disclosed as examples, and with reference to the attached drawings.

FIG. 1 shows a system for controlling signal decoding in a number of subscriber receivers according to a first embodiment of the invention,

FIG. 2 shows a system for controlling signal decoding in a number of subscriber receivers according to a second embodiment of the invention,

FIG. 3 illustrates, by means of a first example, how the signal decoding according to an embodiment of the invention may be controlled between different distribution resources, and

FIG. 4 illustrates, by means of a second example, how the signal decoding according to an embodiment of the invention may be controlled between different distribution resources.

### DESCRIPTION OF PREFERRED EMBODIMENTS OF THE INVENTION

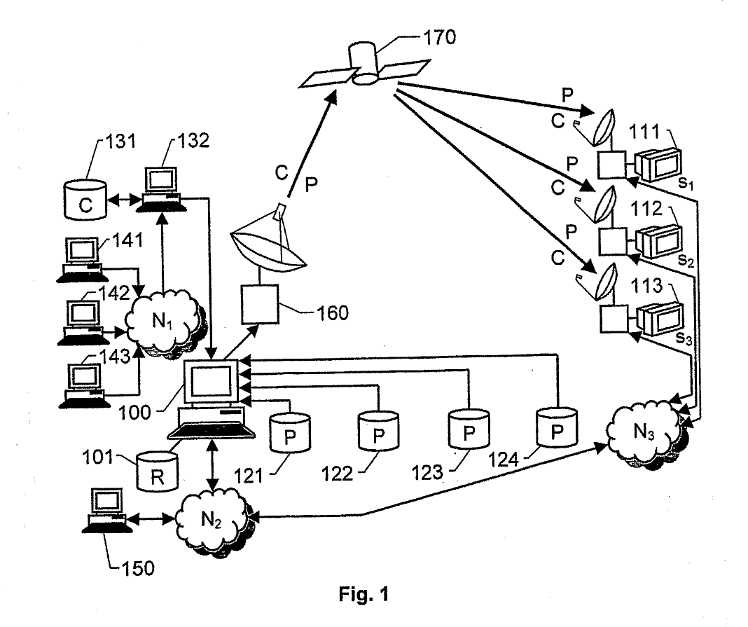

A system for controlling signal decoding in a number of subscriber receivers 111-113 according to a first embodiment of the invention is shown in FIG. 1. The system makes it possible for a set of channel distributors to transmit program signals P and signals C, which represent commercial messages to a number of subscribers s₁-s₃. In the example shown in the figure, this transmission is effected via a satellite link. The invention is, however, applicable to arbitrary alternative mass distribution method, such as radio broadcasting, terrestrial television, cable television or other physical network.

The channel distributors have, via a respective client 141-143 either directly, or via a communications network N₁, contact with a program planning server 132. This server 132 in turn has a connection to a first storage resource 131 from which signals C, which represent commercial or other directed messages can be retrieved. Moreover, the program planning server 132 can, through a connection, exchange information with a central computer 100 via which various kinds of programs P are obtainable from one or more program distributors. The figure illustrates this by means of four storage resources 121-124. According to an embodiment of the invention, at least some of the programs P are also available via the first storage resource 131.

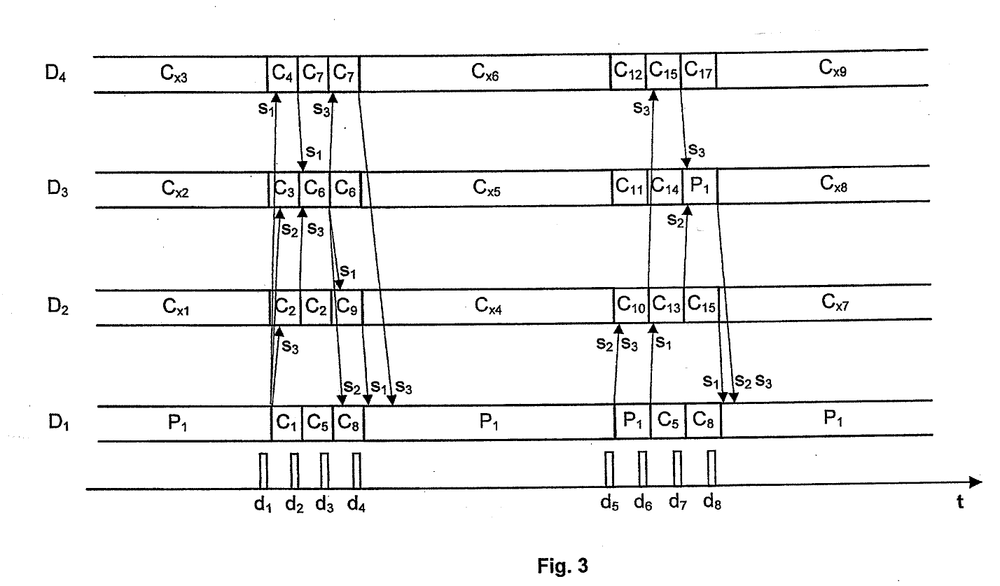

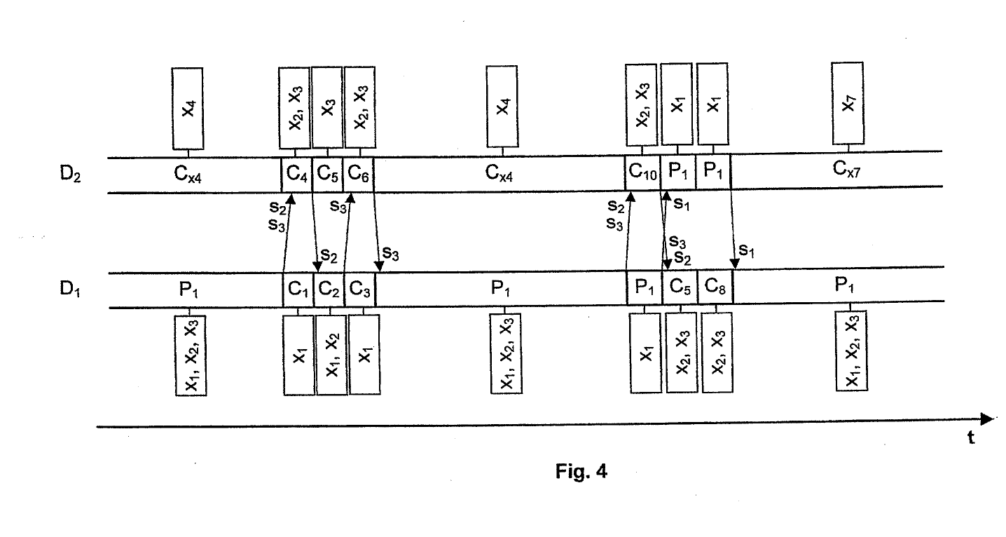

In accordance with the channel distributors' desires the central computer 100 compiles control orders and signal flows in the form of programs P and commercial information C to at least one transmission resource, which is here represented by a satellite transmitter 160 and a geostationary satellite 170. The satellite 170 relays the signals P and C further to subscriber receivers 111-113 each of which is associated with at least one subscriber s₁-s₃. Typically, the subscriber receivers 111-113 may only decode those signals P, C which correspond to a valid subscription that the respective subscriber s₁-s₃ has with one or more of the channel distributors. The subscriber receivers' 111-113 capability to decode the signals P, C may, for example be determined by means of a label being associated with each signal P, C in relation to a stored piece of information R pertaining to the corresponding subscriber s₁-s₃. The stored piece of information R thus includes data pertaining to whether the subscriber s₁-s₃ has signed a subscription with the channel distributor in question and hence is authorized to gain access to the signal P, C. According to a preferred embodiment of the invention, the information R is stored in a database 101, which is available from the central computer 100. According to the invention, however, the information R also includes characteristic data regarding each of the subscribers s₁-s₃, which may be interesting for a potential transmitter of a directed message (for example from an advertiser), such as age, gender, civil status, type of housing, household size, occupation, employment or other affiliation to a particular group. Moreover, the information R may contain data pertaining to the geographical position of the respective subscriber s₁-s₃. It is namely thereby possible to control the signal decoding in a particular subscriber receiver 111-113 on basis of the stored piece of information R such that a given directed message is adapted to a corresponding subscriber's s₁-s₃ expected field of interest. This will be discussed in further detail below with reference to FIGS. 3 and 4. In case one or more data fields in the information R lacks data (i.e. are empty) a default value is allocated, such that an apt control of any directed messages nevertheless can be accomplished.

A first means in the central computer 100 thus makes possible transmission of a control signal there from to a first set of subscriber receivers, which decode a signal P being transmitted via a first distribution resource in connection with that the signal P changes from representing a first type of information to instead represent a second type of information.

A second means in the central computer 100 then makes it possible to control the signal decoding in the respective subscriber receivers in the first set from the first distribution resource to at least one second distribution resource on basis of the stored information R in the database 101 pertaining to each subscriber s₁-s₃ that is associated with the respective subscriber receiver.

According to a preferred embodiment of the invention, the subscriber receivers 111-113 are also connected with the central computer 100, either directly or via one or more communications networks N₃; N₂. Such connections make it possible for the central computer 100 to control the subscriber receivers' 111-113 decoding of the signals P; C based on the labels associated thereto, for example at changes in subscriptions or channel plans. Moreover, information pertaining to the subscribers' s₁-s₃ channel choices (i.e. choice of distribution resource) may be registered and returned to the central computer 100 via these connections. The central computer 100 may thereby compile the choices of distribution resources in relation to the already stored information R and, in the future, control the signal decoding in the subscriber receivers 111-113 based on the compilation, such that the expected relevance of the directed signals C is further increased. Furthermore, the compilation may serve as a support for the central computer when generating automatic proposals regarding programs that are considered to be interesting for the respective subscriber s₁-s₃.

According to a preferred embodiment of the invention, the satellite transmitter 160 includes means for digitizing the signals P; C and possibly compression, packeting and/or multiplexing before the signals P; C are transmitted to the satellite 170. Such digitizing may for example involve grouping of a set of channels, say five, for common transmission together with a data channel, where the bandwidth for each channel is variable between a lowest and a highest value, say 1.5-6.5 Mbit/s. Besides the data channel, a data filed is preferably associated with each individual channel, for example for transmission of a program identity and the proposed labels.

According to yet another preferred embodiment of the invention, two or more subscribers may be associated with one and the same subscriber receiver. The different subscribers then specify their identity to the central compute 100 by activating a specific image/icon or corresponding being related to the subscriber by means of a remote control associated with the subscriber receiver. Thereby, the control of directed signals to the subscriber receiver may vary depending on which subscriber that currently is identified as being active. Moreover, the central computer 100 may gradually store updated data within the information R in the database 101 regarding the different subscribers' viewer behaviors, such that for example a relatively brief initial information about a subscriber is built up over time to represent a fairly detailed picture of this subscriber's preferences. As a complement to this, at least some of the data in the information R pertaining to a particular subscriber may be stored locally in a relevant subscriber receiver 111-113 at the subscriber s₁-s₃.

According to still another preferred embodiment the subscribers, either via the remote control or by means of direct control of the subscriber receiver, may sort, search and select programs and channels based on their contents, language, transmission areas, target groups etc. The information on which this is based is transmitted together with the corresponding signals in the form of associated labels and/or within a data field, which is associated with one or more distribution resources for the signals. The subscribers may, however, neither change or delete the labels or their contents, but such manipulations may only be effected via the central computer 100.

According to another embodiment, the subscriber is offered access to extra information being transmitted in parallel with the signals relating to products/services, which are advertised via the directed signals C. Provided that the stored information R includes billing and/or credit data the subscriber may also order the corresponding products/services by entering a personal code. Thereby, no sensitive payment data needs to be transmitted in order to accomplish a purchase, which of course is beneficial from a security point-of-view. Naturally, the payment function may also be connected with various kinds of billing systems, such as complete payment for subscriptions in the electronic channel distribution system. According to a preferred embodiment of the invention, a respective subscriber receiver is associated with a geographical position. The stored information R may either include geographical data, such as a zip/postal code, a region or group record, or the subscriber receiver may include some kind of positioning equipment, such as a GPS-receiver. Thereby, the system may, for instance, provide information as to where the closest manufacturer, retailer or service station is located for a certain product.

According to another embodiment of the invention, the subscriber receivers 111-113 are connected to a respective input member for manual indication of position data, for example in the form of a zip/postal code or address. The subscriber receivers 111-113 may, of course, be adapted to likewise send this information to the central computer 100. The position data may constitute a basis for which signals P; C that are decoded in the subscriber receivers 111-113. Typically, the position data may be utilized for a graphical presentation of user information to the operator, for example on a map where each subscriber is represented by his geographical position. A digital graphical interface may present information and statistics related to a specific user or group of users on the map in connection with this user's position.

According to still a preferred embodiment the central computer 100 is controlled by an operator of the system, either directly or via an operator client 150, which is connected thereto via a communications network N₂. The operator may thereby also manually plan, coordinate and adjust the transmission of the signal flows P and C over the available transmission resources.

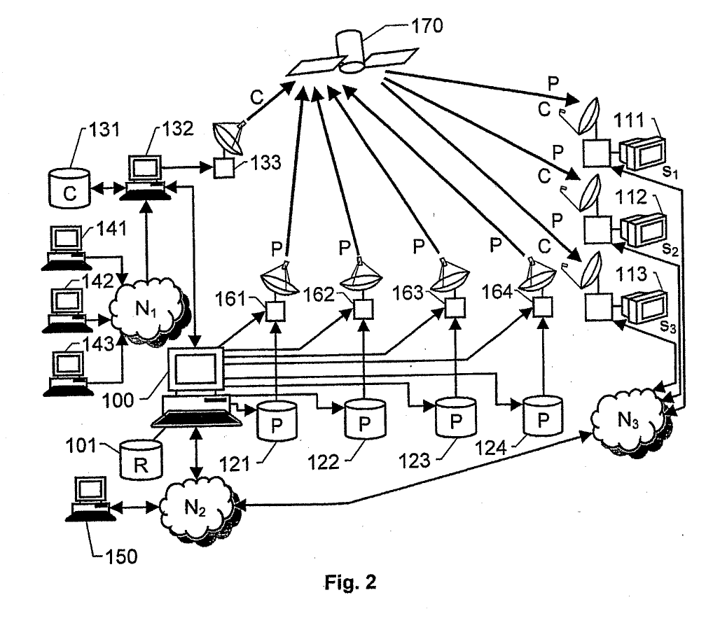

FIG. 2 shows a system for controlling signal decoding according to a second embodiment of the invention. The most important difference between this embodiment and the embodiment, which has been described above is that the signals P and C here do not pass via the central computer 100. However, the central computer 100 controls the transmission of all signals P; C in the same way as in the previous embodiment.

It is thus possible also in this case for a set of channel distributors to transmit program signals P and signals C, which represent commercial messages to a number of subscribers s₁-s₃. FIG. 2 shows that this transmission takes place via distributed and separate satellite transmitters 161-164 and 132 respectively and a geostationary satellite 170. Naturally, the transmission of the signals P; C may equally well be accomplished via a satellite transmitter being common to two or more storage resources 121-124; 131. In similarity with the previous embodiment, this embodiment of the invention is also applicable to arbitrary mass distribution method, such as radio broadcasting, terrestrial television or cable television.

The channel distributors have, by means of a respective client 141-143, either directly or via a communications network N₁, contact with a program planning server 132. This server 132 in turn has contact with the storage resource 131 from which signals C, which represent commercial or other directed messages may be retrieved. Moreover, the program planning server 132 may exchange information with the central computer 100 through which one or more program distributors make various kinds of programs P available. The figure illustrates this by means of the four storage resources 121-124.

In accordance with the channel distributors' desires the central computer 100 compiles control orders and signal flows in the form of programs P and commercial information C to at least one transmission resource, which is here represented by a set of satellite transmitters 161-164 and a geostationary satellite 170. The satellite 170 relays the signals P and C further to subscriber receivers 111-113 each of which is associated with at least one subscriber s₁-s₃. Typically, the subscriber receivers 111-113 may only decode those signals P, C which correspond to a valid subscription that the respective subscriber s₁-s₃ has with one or more of the channel distributors. The subscriber receivers' 111-113 capability to decode the signals P, C may, for example be determined by means of a label being associated with each signal P, C in relation to a stored piece of information R pertaining to the corresponding subscriber s₁-s₃. The stored piece of information R thus includes data pertaining to whether the subscriber s₁-s₃ has signed a subscription with the channel distributor in question and hence is authorized to gain access to the signal P, C. According to a preferred embodiment of the invention, the information R is stored in a database 101, which is available from the central computer 100. According to the invention, however, the information R also includes characteristic data regarding each of the subscribers s₁-s₃, which may be interesting for a potential transmitter of a directed message (for example from an advertiser), such as age, gender, civil status, type of housing, household size, occupation, employment or other affiliation to a particular group. Moreover, the information R may contain data pertaining to the geographical position of the respective subscriber s₁-s₃. It is namely thereby possible to control the signal decoding in a particular subscriber receiver 111-113 on basis of the stored piece of information R such that a given directed message is adapted to a corresponding subscriber's s₁-s₃ expected field of interest. This will be discussed in further detail below with reference to FIGS. 3 and 4.

According to a preferred embodiment of the invention, the labels associated with a respective signal P; C include time information, which makes it possible to accomplish a time limited control of the decoding of the signals P; C in the subscriber receivers 111-113 from the central computer 100 over a communications network N₃, such that for example a particular signal P or C at a given moment is replaced by a different signal P or C, alternatively by the absence of a signal.

A first means in the central computer 100 makes it possible to transmit a control signal there from to a first set of subscriber receivers, which decode a signal P being transmitted via a first distribution resource in connection with that the signal P changes from representing a first type of information to instead represent a second type of information.

A second means in the central computer 100 then makes it possible to control the signal decoding in the respective subscriber receivers in the first set from the first distribution resource to at least one second distribution resource on basis of the stored information R in the database 101 pertaining to each subscriber s₁-s₃ that is associated with the respective subscriber receiver.

According to a preferred embodiment of the invention, the subscriber receivers 111-113 are also connected with the central computer 100, either directly or via one or more communications networks N₃; N₂. Such connections make it possible for the central computer 100 to control the subscriber receivers' 111-113 decoding of the signals P; C based on the labels associated thereto, for example at changes in subscriptions or channel plans. Moreover, information pertaining to the subscribers' s₁-s₃ channel choices (i.e. choice of distribution resource) may be registered and returned to the central computer 100 via these connections. The central computer 100 may thereby compile the choices of distribution resources in relation to the already stored information R and, in the future, control the signal decoding in the subscriber receivers 111-113 based on the compilation, such that the expected relevance of the directed signals C is further increased.

According to a preferred embodiment of the invention, the central computer 100 is controlled by an operator of the system either directly or via an operator client 150, which is either directly connected to the central computer 100 or is connected thereto via a communications network N₂.

FIG. 3 illustrates, by means of a first example, how the signal decoding in a set of subscriber receivers may be controlled between different distribution resources D₁-D₄ according to an embodiment of the invention. The figure shows the distribution resources D₁-D₄ as horizontal and parallel blocks along a time axis t. Signals of different kinds (for example “programs”, “commercials” or “directed messages to authorization limited groups”), are represented by the letters P and C. An index denotes a particular contents of the signal.

A first distribution resource D₁ has been reserved by one channel distributor for transmission of a program P₁. A second, a third and a fourth distribution resource D₂, D₃ and D₄ respectively are currently not reserved by a specific channel distributor, but are freely available for the operator. According to a preferred embodiment of the invention, also distribution resources which are normally used for transmitting pause information, may in principle, be utilized freely by the operator by transmitting the pause information to a relevant subscriber receiver where it is subsequently stored. Thereby, the pause information may be replayed locally without burden any distribution resource. However, it may sometimes be necessary to update the pause information at certain intervals by means of a repeated transmission to the subscriber receivers. This, nevertheless, requires very small distribution resources.

The example presumes that the program P₁ initially is distributed via a first distribution resource D₁ to three subscribers s₁, s₂ and s₃ respectively, in respect of which mutually different information R has been registered in the database 101 in the FIGS. 1 and 2. All the subscribers s₁-s₃, however, are authorized to decode the signal that represents the program P₁. This fact is determined by a label being associated with the program P₁ in relation to a stored piece of subscription data in the information R. At a certain point in time, however, there is a commercial break in the program P₁ according to the desires of the channel distributor in question. Thereby, the type of information being transmitted via the distribution resource D₁ also changes from representing the program P₁ to representing a commercial C₁. In connection with that the information type of the signal is altered a control signal d₁ is transmitted from the central computer 100 to the subscribers' s₁-s₃ subscriber receivers. The control signal d₁ is transmitted a particular time before the information type is changed, either by means of in-band signaling within the distribution resource D₁ or via a separate channel.

Since, based on the stored pieces of information R, none of the subscribers s₁-s₃ is expected to be interested in the contents of the commercial C₁ their subscriber receivers are instead controlled such that they decode alternative commercials C₄, C₃ and C₂, which are transmitted via the distribution resources D₄, D₃ and D₂ respectively.

A particular time before the information type on the distribution resources D₁-D₄ again is changed the central computer 100 transmits a new control signal d₂ and the subscribers' s₁-s₃ subscriber receivers are once more controlled to decode a signal C₆ via the distribution resource D₃ being most relevant to each subscriber s₁-s₃. In this case, one and the same item was thus estimated to represent the most relevant information to all the subscribers s₁-s₃. After yet another time interval the central computer 100 transmits another control signal d₃ whereafter the subscriber receivers are controlled to decode a signal C₉ for the subscriber s₁, a signal C₈ for the subscriber s₂ and a signal C₇ for the subscriber s₃. Subsequently, the signal being transmitted via the distribution resource D₁ continues to represent the program P₁, which is preceded by the central computer 100 a particular time prior to that transmitting a control signal d₄ to the subscribers' s₁-s₃ subscriber receivers.

In connection with the next commercial break in the program P₁ the central computer 100 transmits a control signal d₅ to the subscribers' s₁-s₃ subscriber receivers. This time the subscriber's s₁ subscriber receiver is controlled such that its active distribution resource D₁ remains the same after the change of information type. As a matter of fact, the subscriber's s₁ subscriber receiver continues to decode the same program P₁. However, the other subscribers' s₂; s₃ subscriber receivers are controlled to decode a different signal C₁₀, which is transmitted via an alternative distribution resource D₂. A particular time before the information type on the distribution resources D₁-D₄ again is changed the central computer 100 transmits a new control signal d₆ and the subscribers' s₁-s₃ subscriber receivers are again controlled to decode a respective most relevant signal C₁₃ and C₁₅ transmitted via the distribution resources D₂ and D₄ respectively. At yet a later instance the central computer 100 transmits still another control signal d₇ whereafter the subscriber receivers are controlled to decode a signal C₁₅ for the subscriber s₁ and, for the subscribers s₂ and s₃, the part of the program P₁ which the subscriber's s₁ subscriber receiver decoded after the control signal d₅. Then, the signal that is transmitted via the distribution resource D₁ continues to represent the program P₁, which is preceded by the central computer 100 a particular time prior to that transmitting a control signal d₈ to the subscribers' s₁-s₃ subscriber receivers.

On technical grounds it may be suitable to temporarily buffer a part of the program P₁, which is transmitted via the distribution resource D₁ after the control signal d₅, since this sequence shortly thereafter will be retransmitted via the distribution resource D₃ after the control signal d₇. According to a preferred embodiment of the invention, the buffering is accomplished in the storage resource 131 in the system of the FIGS. 2 and 3 respectively.

FIG. 3 shows general signals Cₓ₁-Cₓ₃ for the distribution resources D₂-D₄ in the time interval before the control signal d₁. Correspondingly, general signals Cₓ₄-Cₓ₆ are shown in the time interval between the control signals d₄ and d₅. This symbolizes that during these time intervals directed signals may be controlled to be decoded in different subscribers' subscriber receivers. Hence, the otherwise unused distribution resources D₂-D₄ may be utilized very efficiently.

FIG. 4 illustrates, by means of a second example, how the signal decoding in a set of subscriber receivers may be controlled between different distribution resources D₁ and D₂ according to an embodiment of the invention. The figure shows the distribution resources D₁ and D₂ as horizontal and parallel blocks along a time axis t. Signals of different kinds (for example “programs”, “commercials” or “directed messages to authorization limited groups”), are represented by the letters P and C. An index denotes a particular contents of the signal. Control signals x₁-x₄ and x₇, which indicate the signal decoding in a particular subscriber receiver are here included in respective labels being associated with the signals P; C that being transmitted via the distribution resources D₁ and D₂.

The control signals x₁-x₄ and x₇ include at least a time stamp, which makes it possible to synchronize the decoded signal when changing between the distribution resources D₁ and D₂. According to a preferred embodiment of the invention, the respective control signal x₁-x₄ and x₇ also represents a certain target group, such as subscribers within a particular age interval.

The illustrated example presumes that the signal decoding for a first subscriber s₁ is determined by a first control signal x₁. Correspondingly, the signal decoding for a second subscriber s₂ is determined by a second control signal x₂ and the signal decoding for a third subscriber s₃ is determined by a third control signal x₃. By registering the labels a respective subscriber receiver may thus decode a suitable signal with respect to the subscriber s₁-s₃ being associated thereto by following “his” control signal x₁-x₃ between the distribution resources D₁ and D₂. As is apparent from the figure, all subscribers' s₁-s₃ subscriber receivers decode directed signals C₁-C₆ during a first commercial break in the program P₁, while only the second and the third subscribers' s₂; s₃ subscriber receivers decode directed signals C₁₀, C₅ and C₈ during a second commercial break in the program P₁. During the same time, the first subscriber s₁ follows the program P₁ without interruption. The time discrepancy caused thereby may, for example, be adjusted at a later interruption in the program P₁.

In practice the labels, which include the control signals x₁-x₄; x₇ are slightly shifted in time, such that the subscriber receivers manage to decode them and possibly change their reception before the corresponding signal arrives at the subscriber receiver. For reasons of clarity, however, this has not been illustrated in the FIG. 4.

According to a preferred embodiment of the invention, each subscriber receiver includes two or more signal receivers which receive signals in parallel. Thereby, a second signal receiver may start decoding in accordance with a particular control signal before decoding via a first signal receiver is discontinued. This in turn alleviates fast changes between the distribution resources.

Naturally an actual change of signal type (i.e. such as from a “program” to a “commercial”) is not a necessary precondition in order to transmit a control signal x₁-x₄; x₇. The invention admits such control signals to be transmitted at any alternative occasion, which is suitable in consideration of the particular application in question. Hence, a control signal may for example be transmitted in connection with a change from one program to another program. The control signals may furthermore be transmitted such that a particular subscriber receiver is caused to follow a certain program that is transmitted alternately or in parallel via two or more distribution resources D₁-D₄.

The invention is not restricted to the embodiments described with reference to the figures, but may be varied freely within the scope of the following claims.

That which is claimed is:

1. A method for controlling signal decoding in two or more subscriber receivers, whereby signals of different types are conveyed via at least two separate distribution resources to the subscriber receivers, where each signal is associated with a label which at least reflects the type of signal, and the possibility for a specific subscriber receiver to decode a certain signal is determined by the label in relation to a stored piece of information regarding at least one subscriber being associated with the subscriber receiver, wherein the method involves
central transmission of a control signal to a first set of subscriber receivers which decode a signal being transmitted via a first distribution resource in connection with the signal changing from representing a first type of information to representing a second type of information, the control signal being transmitted a particular time before said information change of the signal, and
controlling the signal decoding in the first set of subscriber receivers from the first distribution resource to at least one second distribution resource based on the stored pieces of information regarding the at least one subscriber being associated with the respective subscriber receiver and in response to the control signal, where the at least one second distribution resource conveys a second type of information.

2. A method according to claim 1, wherein the method involves transmitting the control signal via a channel which is separate from the at least two separate distribution resources.

3. A method according to claim 1, wherein at least one of the first distribution resource is identical with the at least one second distribution resource and the first type of information is identical with the at least one second type of information.

4. A method according to claim 1, wherein the stored pieces of information comprise characteristic data pertaining to each of the subscribers, and the control of the signal decoding depending on the stored pieces of information such that the at least one second type of information is adapted to the respective subscriber.

5. A method according to claim 4, wherein two or more subscribers being associated with a particular subscriber receiver, each of said two or more subscribers having a separate identity, and the method involving controlling the signal decoding in the particular subscriber receiver depending on which subscriber that currently is identified as being active.

6. A method according to claim 4, wherein the at least one second type of information comprises a commercial message.

7. A method according to claim 4, wherein the at least one second type of information constitutes a directed message to an authorization limited group.

8. A method according to claim 1, wherein the method involves:
registering data pertaining to the subscribers' choice of distribution resource,
compilation of the data pertaining to the subscribers' choice of distribution resource in relation to the stored pieces of information, and
controlling future signal decoding in the subscriber receivers on basis of the compilation.

9. A system for controlling signal decoding in two or more subscriber receivers, where signals of different types are conveyed from a central transmission unit to the subscriber receivers via at least two separate distribution resources, where each signal is associated with a particular label which at least reflects the type of signal and the possibility for a specific subscriber receiver to decode a certain signal is determined by the label in relation to a stored piece of information regarding at least one subscriber being associated with the subscriber receiver, the system containing a central control unit, which in turn comprises
means for transmitting a control signal to a first set of subscriber receivers which decode a signal being transmitted via a first distribution resource in connection with the signal changing from representing a first type of information to representing a second type of information, said transmission means being adapted to transmit the control signal a particular time before said information change of the signal, and
means for controlling the signal decoding in each subscriber receiver in the first set from the first distribution resource to at least one second distribution resource based on the stored pieces of information regarding the respective subscriber being associated with the subscriber receivers and in response to the control signal, and where the at least one second distribution resource conveys at least one second type of information.

10. A system according to claim 9, wherein said transmission means in the central control unit is adapted to transmit the control signal via a channel which is separate from the at least two separate distribution resources.

11. A system according to claim 9, wherein the system comprises a database for storing the pieces of information pertaining to the at least one subscriber and the database is accessible from the central control unit.

12. A system according to claim 9, wherein the system comprises a central transmission unit.

13. A system according to claim 12, wherein the system comprises
a first storage resource containing signals which represent directed messages, at least one second storage resource containing signals which represent programs, a program planning server being connected with the first storage resource and the at least one second storage resource and being adapted to exchange information with the central control unit such that signals representing programs and directed messages respectively are assigned to at least one of the distribution resources for transmission via the central transmission unit, and at least one client being connected with the program planning server and which thereby may influence the assigning of programs and directed messages to the distribution resources.

14. A system according to claim 9, wherein the signals represent at least one of text information, acoustic information, image information and video information.

15. A system according to claim 14, wherein the first type of information represents TV-programs and the second type of information represents commercials.

16. A system according to claim 9, wherein the system further comprises at least one communications network through which information is exchangeable between the central control unit and the subscriber receiver.

17. A system according to claim 9, wherein the subscriber receiver comprises a global positioning system receiver, which is arranged to convey positional information.

18. A system according to claim 9, wherein the subscriber receiver is connected to a respective input member for manual indication of position data.

19. A system according to claim 9, wherein the subscriber receiver includes two or more signal receivers which receive signals in parallel and thereby, a second signal receiver is enabled to start decoding in accordance with a particular control signal before decoding via a first signal receiver is discontinued.
